(19) United States
(12) Patent Application Publication
(10) Pub. No.: US 2025/0170697 A1
(43) Pub. Date: May 29, 2025

(54) AUXILIARY HANDLE FOR TOOLS

(71) Applicant: Zhejiang Feihu New Energy Technology Co., Ltd., Jinhua (CN)

(72) Inventor: Feibiao ZHANG, Jinhua (CN)

(73) Assignee: Zhejiang Feihu New Energy Technology Co., Ltd., Jinhua (CN)

(21) Appl. No.: 18/954,444

(22) Filed: Nov. 20, 2024

(30) Foreign Application Priority Data
Nov. 24, 2023 (CN) 202323187551.7

(51) Int. Cl. B25G 1/04

(52) U.S. Cl. CPC B25G 1/04

(57) ABSTRACT

The present disclosure relates to the technical field of auxiliary handles, in particular to an auxiliary handle for tools, which comprises a complete machine product. A complete machine connecting fixing seat connected with the complete machine product is arranged in the complete machine product, and the complete machine product is provided with an auxiliary handle component which is convenient to hold by hand through the complete machine connecting fixing seat, and easily used by an arm and a body of an operator in a natural relaxed state. Compared with the prior art, a position and a use angle of a structure of the auxiliary handle for tools can are adjusted according to different heights of operators to meet use needs of different operators. Comfort of the users is adjusted according to different complete machine products and different centers of gravity.

### RELATED APPLICATIONS

The present patent document claims the benefit of priority to Patent Application No. 20/2323187551.7, filed Nov. 24, 2023, and entitled “AUXILIARY HANDLE FOR TOOLS,” the entire contents of each of which are incorporated herein by reference.

### BACKGROUND

### 1. Technical Field

The present disclosure relates to the technical field of auxiliary handles, and particularly, to an auxiliary handle for tools.

### 2. Background Information

A handle is connected with an implement and is convenient for people to hold.

Traditional tool handles are mostly D-type, P-type and open-type auxiliary handles, which are not comfortable to use and cannot be adjusted. After long-term use, the traditional tool handles will cause problems such as cervical spine and arm pain, and may even cause occupational diseases to professional tool users.

The present disclosure with Chinese patent publication number CN208677284U is named as a handle of a vacuum cleaner. The vacuum cleaner comprises an upper part and a lower part. The upper part is detachably connected with the lower part, and the lower part comprises a dust collection cup, wherein the handle comprises: a first longitudinal section, a lower end of which is connected with a bottom end of the upper part; a second longitudinal section, a lower end of which is connected with a top end of the upper part; a transverse section, a first end of which is connected with an upper end of the first longitudinal section, and a second end of which is connected an upper end of the second longitudinal section; and a key part arranged on an upper side of the first end of the transverse section, wherein the key part is provided with an on-off key for controlling on-off of the vacuum cleaner and an adjusting key for adjusting suction of the vacuum cleaner, and a holding space is left between the transverse section and the top end of the upper part. It can be known from the solution and the attached drawings that the handle is not easy to adjust when in use, so it is difficult to adapt to the use of some people, and some people's arms are easy to ache when using the handle for a long time, so an auxiliary handle for tools is proposed.

### BRIEF SUMMARY

### (I) Technical Problems to be Solved

In view of the shortcomings of the prior art, the present disclosure provides an auxiliary handle for tools, wherein a position and a use angle of the structure can be adjusted according to different heights, so as to meet the needs of users with different heights and arm lengths, and can adjust comfort of the users according to different lengths of operating rods and different centers of gravity.

### (II) Technical Solution

In order to achieve the above objects, the present disclosure is realized by the following technical solution: an auxiliary handle for tools comprises a complete machine product, wherein the complete machine product is provided with a complete machine connecting fixing seat connected with the complete machine product, and an auxiliary handle component convenient to hold by hand is installed on the complete machine product through the complete machine connecting fixing seat. Due to the arrangement of the auxiliary handle component, the auxiliary handle for tools can be easily used when an arm and a body of an operator are in a natural relaxed state.

Alternatively, the complete machine product is provided with the detachable complete machine connecting fixing seat, the auxiliary handle component comprises a connecting rod part, the connecting rod part is arranged in the complete machine connecting fixing seat, and an end part of one end of the connecting rod part is provided with a hand-held rod movably connected with the connecting rod part. The complete machine connecting fixing seat may be adjusted according to a height of the operator, which is used for the subsequent installation of the auxiliary handle component to improve comfort of the operator.

Alternatively, the movable connection between the connecting rod part and the hand-held rod is implemented in a folding, telescoping or plug-in locking manner. The connection between the connecting rod part and the hand-held rod is disconnected connection, which is preferably folded connection to facilitate storage and transportation.

Alternatively, a cross section of the connecting rod part in a vertical state is L-shaped, a cross section of the hand-held rod in a flat state is left-inverted L-shaped, and a cross bar in the connecting rod part with the L-shaped cross section in the vertical state is parallel to a cross bar in the hand-held rod with the left-inverted L-shaped cross section in the flat state.

Alternatively, the complete machine connecting fixing seat is provided with an auxiliary handle fixing seat for positioning the connecting rod part, and the auxiliary handle fixing seat is provided with an auxiliary handle adjusting screw for limiting the connecting rod part.

Alternatively, an end part of the other end of the connecting rod part is provided with a handle rod plug, and a hand-held part of the hand-held rod is provided with a soft rubber handle sleeve.

Alternatively, the auxiliary handle component comprises a connecting rod part and a hand-held rod, the connecting rod part is arranged in the complete machine connecting fixing seat, an end part of one end of the connecting rod part is provided with the hand-held rod movably connected with the connecting rod part, a foldable component is arranged between the connecting rod part and the hand-held rod, the foldable component comprises a left toothed component, a right toothed component, a toothed screw and a toothed nut, the toothed screw is inserted into through holes of the left toothed component and the right toothed component, the toothed screw is fixedly connected with the toothed nut in a spiral way, and the left toothed component and the right toothed component are connected by meshing. A toothed meshing structure is adopted at a bent joint, which not only changes a bending angle through toothed meshing, but also has a strong supporting force, and multi-angle adjustment is convenient for people of different heights to use a lawn mower.

Alternatively, the toothed screw is a hexagonal screw, and the toothed nut is a torispherical nut.

Compared with the prior art, the position and the use angle of the structure of the auxiliary handle for tools can be adjusted according to different heights of operators, so as to meet the use of different operators. The comfort of the users can be adjusted according to different complete machine products and different centers of gravity.

### BRIEF DESCRIPTION OF THE DRAWINGS

FIG. 1 is a schematic diagram showing an overall structure of the present disclosure;

FIG. 2 is a schematic structural diagram of a complete machine product according to the present disclosure;

FIG. 3 is a structural schematic diagram of the auxiliary handle for tools according to the present disclosure;

FIG. 4 is a schematic structural diagram of a foldable auxiliary handle component according to the present disclosure; and

FIG. 5 is an exploded drawing of the foldable auxiliary handle member according to the present disclosure.

In the drawings: 1—complete machine product; 2—complete machine connecting fixing seat; 3—auxiliary handle component; 4—connecting rod part; 5—hand-held rod; 6—auxiliary handle fixing seat; 7—auxiliary handle adjusting screw; 8—handle rod plug; 9—soft rubber handle sleeve; 51—foldable component; 51—foldable component; 511—left toothed component; 512—right toothed component; 513—toothed screw; and 514—toothed nut.

### DETAILED DESCRIPTION OF THE DRAWINGS AND THE PRESENTLY PREFERRED EMBODIMENTS

The following clearly and completely describes the technical solutions in the embodiments of the present disclosure with reference to the drawings in the embodiments of the present disclosure. Apparently, the described embodiments are merely some but not all of the embodiments of the present disclosure.

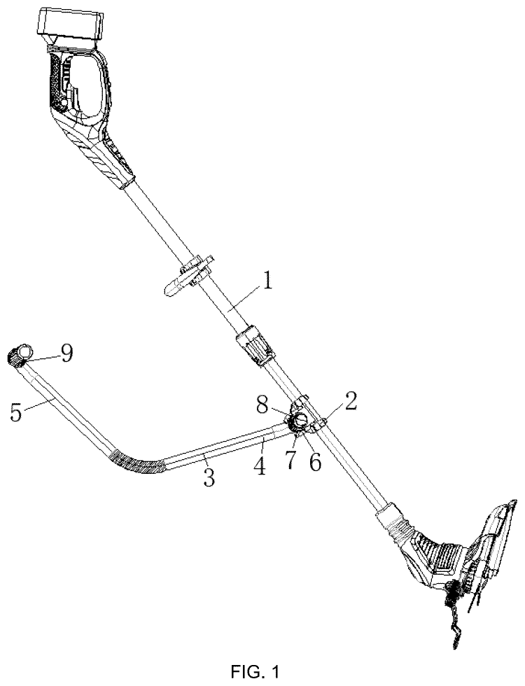

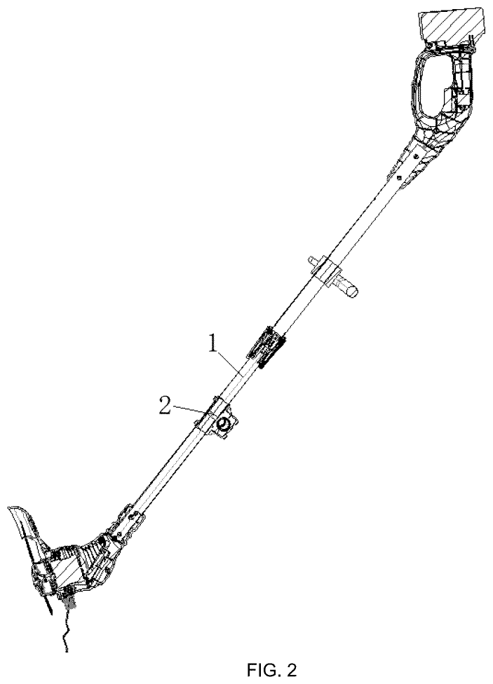

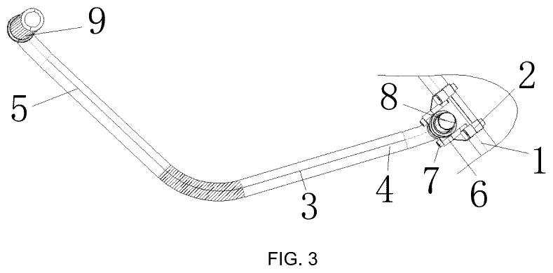

According to a first embodiment, referring to FIG. 1 to FIG. 3, the present disclosure provides a technical solution: An auxiliary handle for tools comprises a complete machine product 1. The complete machine product 1 is provided with a complete machine connecting fixing seat 2 connected with the complete machine product 1, and an auxiliary handle component 3 convenient to hold by hand is installed on the complete machine product 1 through the complete machine connecting fixing seat 2. The complete machine product 1 is provided with the detachable complete machine connecting fixing seat 2, the auxiliary handle component 3 comprises a connecting rod part, the connecting rod part is arranged in the complete machine connecting fixing seat 2, and an end part of one end of the connecting rod part 4 is provided with a hand-held rod 5 movably connected with the connecting rod part 4. The movable connection between the connecting rod part 4 and the hand-held rod 5 is implemented in a folding, telescoping or plug-in locking manner. A cross section of the connecting rod part 4 in a vertical state is L-shaped, a cross section of the hand-held rod 5 in a flat state is left-inverted L-shaped, and a cross bar in the connecting rod part 4 with the L-shaped cross section in the vertical state is parallel to a cross bar in the hand-held rod 5 with the left-inverted L-shaped cross section in the flat state. The complete machine connecting fixing seat 2 is provided with an auxiliary handle fixing seat 6 for positioning the connecting rod part 4, and the auxiliary handle fixing seat 6 is provided with an auxiliary handle adjusting screw 7 for limiting the connecting rod part 4. An end part of the other end of the connecting rod part 4 is provided with a handle rod plug 8, and a hand-held part of the hand-held rod 5 is provided with a soft rubber handle sleeve 9.

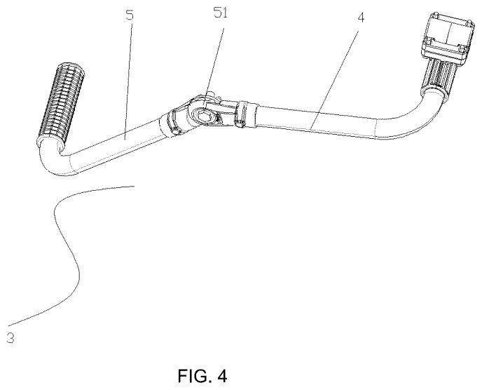

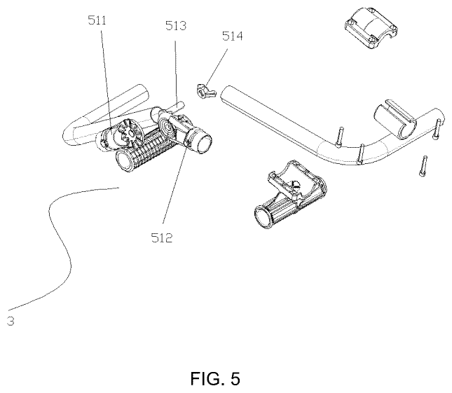

According to a second embodiment, referring to FIG. 4 to FIG. 5, the present disclosure provides a technical solution: an auxiliary handle for tools, wherein:
the auxiliary handle component 3 comprises a connecting rod part and a hand-held rod 5. The connecting rod part 4 is arranged in the complete machine connecting fixing seat 2, and an end part of one end of the connecting rod part 4 is provided with the hand-held rod 5 movably connected with the connecting rod part 4. A foldable component 51 is arranged between the connecting rod part 4 and the hand-held rod 5. The foldable component 51 comprises a left toothed component 511, a right toothed component 512, a toothed screw 513 and a toothed nut 514. The toothed screw 513 is inserted into through holes of the left toothed component 511 and the right toothed component 512. The toothed screw 513 is fixedly connected with the toothed nut 514 in a spiral way, and the left toothed component 511 and the right toothed component 512 are connected by meshing. The toothed screw 513 is a hexagonal screw, and the toothed nut 514 is a torispherical nut.

In this way, an angle of the auxiliary handle for tools can be adjusted entirely, which is convenient to store a fixing rod, reduces a transportation cost with large volume, and adjust a distance between the handles. The handle rod can be bent by 144 degrees, 108 degrees and 180 degrees at multiple angles to adjust a folding angle. The auxiliary handle for tools adopts a toothed meshing structure at a bent joint, which not only changes a bending angle through toothed meshing, but also has a strong supporting force, so multi-angle adjustment is realized, which is convenient for people of different heights to use a lawn mower.

Electrical elements herein are all electrically connected with an external primary controller and 220V commercial power, and the primary controller may be a conventional known device for controlling such as a computer, and the like.

In the description of the specification, the terms “connection”, “installation”, “fixing” and “setting” are all broadly understood. For example, “connection” can be a fixed connection or an indirect connection through intermediate components without affecting the relationship between members and technical effects, or an integral connection or a partial connection. As in this case, it will be appreciated by those of ordinary skills in the art that the specific meanings of the above terms in the present disclosure may be understood according to specific conditions.

The foregoing descriptions are merely preferred embodiments of the present disclosure, but the protection scope of the present disclosure is not limited thereto. Equivalent substitutions or changes made by any person skilled in the art within the technical scope of the present disclosure and based on the technical solution of the present disclosure and the concept of the present disclosure shall be included in the protection scope of the present disclosure.

1. An auxiliary handle for tools, comprising a complete machine product (1), wherein the complete machine product (1) is provided with a complete machine connecting fixing seat (2) connected with the complete machine product (1), and an auxiliary handle component (3) convenient to hold by hand is installed on the complete machine product (1) through the complete machine connecting fixing seat (2).

2. The auxiliary handle for tools according to claim 1, wherein the complete machine product (1) is provided with the detachable complete machine connecting fixing seat (2), the auxiliary handle component (3) comprises a connecting rod part (4), the connecting rod part (4) is arranged in the complete machine connecting fixing seat (2), and an end part of one end of the connecting rod part (4) is provided with a hand-held rod (5) movably connected with the connecting rod part (4).

3. The auxiliary handle for tools according to claim 2, wherein the movable connection between the connecting rod part (4) and the hand-held rod (5) is implemented in a folding, telescoping or plug-in locking manner.

4. The auxiliary handle for tools according to claim 2, wherein a cross section of the connecting rod part (4) in a vertical state is L-shaped, a cross section of the hand-held rod (5) in a flat state is left-inverted L-shaped, and a cross bar in the connecting rod part (4) with the L-shaped cross section in the vertical state is parallel to a cross bar in the hand-held rod (5) with the left-inverted L-shaped cross section in the flat state.

5. The auxiliary handle for tools according to claim 2, wherein the complete machine connecting fixing seat (2) is provided with an auxiliary handle fixing seat (6) for positioning the connecting rod part (4), and the auxiliary handle fixing seat (6) is provided with an auxiliary handle adjusting screw (7) for limiting the connecting rod part (4).

6. The auxiliary handle for tools according to claim 2, wherein an end part of the other end of the connecting rod part (4) is provided with a handle rod plug (8), and a hand-held part of the hand-held rod (5) is provided with a soft rubber handle sleeve (9).

7. The auxiliary handle for tools according to claim 1, wherein the auxiliary handle component (3) comprises a connecting rod part (4) and a hand-held rod (5), the connecting rod part (4) is arranged in the complete machine connecting fixing seat (2), an end part of one end of the connecting rod part (4) is provided with the hand-held rod (5) movably connected with the connecting rod part (4), a foldable component (51) is arranged between the connecting rod part (4) and the hand-held rod (5), the foldable component (51) comprises a left toothed component (511), a right toothed component (512), a toothed screw (513) and a toothed nut (514), the toothed screw (513) is inserted into through holes of the left toothed component (511) and the right toothed component (512), the toothed screw (513) is fixedly connected with the toothed nut (514) in a spiral way, and the left toothed component (511) and the right toothed component (512) are connected by meshing.

8. The auxiliary handle for tools according to claim 7, wherein the toothed screw (513) is a hexagonal screw, and the toothed nut (514) is a torispherical nut.
